(19) United States
(12) Patent Application Publication
(10) Pub. No.: US 2002/0199116 A1
(43) Pub. Date: Dec. 26, 2002

(54) System and method for computer network virus exclusion

(76) Inventors: Keith Hoene, Boise, ID (US); William I. Herrmann, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/887,816

(22) Filed: Jun. 25, 2001

(51) Int. Cl. G06F 11/30

(52) U.S. Cl. 713/201

(57) ABSTRACT

A method of network virus exclusion comprises identifying client computers that are at least one of virus susceptible and virus infected, and isolating those virus susceptible client computers and virus infected client computers from authorized communication with a server of the network. A virus exclusion network system comprises a client computer including a virus protector and a network server including a virus monitor. The virus monitor is configured for preventing an authorized network connection between the client computer and the server when the client computer fails to produce at least one of a report an up-to-date virus scan of the client computer and a report of enablement of the virus protector of the client computer.

### THE FIELD OF THE INVENTION

The present invention relates to computer networks, and in particular, to excluding viruses from a computer network.

### BACKGROUND OF THE INVENTION

No type of property is immune from vandals. In the information age, vandals entertain themselves by sabotaging computers. One of the most common attacks is spreading viruses throughout computer networks, both public and private. While some viruses are a mere nuisance, other viruses destroy valuable information and greatly disrupt business and personal productivity.

Fortunately, most conscientious computer users avoid serious injury from viruses since virus-protection companies in the computer industry continually develop technology and software for eradicating viruses. However, in some networks, such as client-server networks, just one irresponsible or forgetful client can permit a virus to plague a network. Despite the heroic efforts of network administrators, new viruses replicate throughout networks. In response, the network administrators painstakingly comb through all the client computers, storage media, and input/output devices to eradicate the virus using an appropriate virus definition file. Unfortunately, after this system-wide eradication, this same virus can re-infect a network through careless acts of clients in the network.

Accordingly, while virus-defeating technology appears to keep up with malicious computer hackers, implementing this technology in a foolproof manner remains challenging for network system administrators.

### SUMMARY OF THE INVENTION

A method of network virus exclusion of the present invention comprises identifying client computers that are virus-susceptible and/or virus-infected and isolating those virus susceptible client computers and virus infected client computers from authorized communication with a server of the network.

A virus exclusion network system of the present invention comprises a client computer including a virus protector and a network server including a virus monitor. The virus monitor is configured for preventing an authorized network connection between the client computer and the server when the client computer fails to produce at least one of a report an up-to-date virus scan of the client computer and a report of enablement of the virus protector of the client computer.

### BRIEF DESCRIPTION OF THE DRAWINGS

FIG. 1 is a block diagram of a virus exclusion network computing system, according to one embodiment of the present invention.

FIG. 2 is a block diagram of a virus monitor of a virus exclusion network computing system, according to one embodiment of the present invention.

FIG. 3 is a flow diagram of a method of network virus exclusion, according to one embodiment of the present invention.

FIG. 4 is a flow diagram of an alternate method of network virus exclusion, according to one embodiment of the present invention.

FIG. 5 is a flow diagram of an alternate method of network virus exclusion, according to one embodiment of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

Components of the present invention may be implemented in hardware via a microprocessor, programmable logic, or state machine, in firmware, or in software within a given device. In one aspect, at least a portion of the software programming is web-based and written in HTML and JAVA programming languages, including links to graphical user interfaces, such as via windows-based operating system. The components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may reside in software on one or more computer-readable media. The term computer-readable media as used herein is defined to include any kind of memory, volatile or non-volatile, such as floppy disks, hard disks, CD-ROMs, flash memory, read-only memory (ROM), and random access memory (RAM).

Preferably, the user interfaces described herein run on a controller, computer, appliance or other device having an operating system which can support one or more applications. The operating system is stored in memory and executes on a processor. The operating system is preferably a multi-tasking operating system which allows simultaneous execution of multiple applications, although aspects of this invention may be implemented using a single-tasking operating system. The operating system employ a graphical user interface windowing environment which presents the applications or documents in specially delineated areas of the display screen called “windows.” Each window has its own adjustable boundaries which allow the user to enlarge or shrink the application or document relative to the display screen. Each window can act independently, including its own menu, toolbar, pointers, and other controls, as if it were a virtual display device. Other software tools may be employed via the window, such as a spreadsheet for collecting data. The operating system preferably includes a windows-based dynamic display which allows for the entry or selection of data in dynamic data field locations via an input device such as a keyboard and/or mouse. One preferred operating system is a Windows® brand operating system sold by Microsoft Corporation. However, other operating systems which provide windowing environments may be employed, such as those available from Apple Corporation or IBM. In another embodiment, the operating system does not employ a windowing environment.

A system and method for network virus exclusion of the present invention isolates virus-susceptible clients and virus-infected clients from a server of a network and from other network clients to prevent virus transmission throughout the network. Virus-suspectible clients and virus-infected clients are identified by a virus monitor of the server and are terminated from connection to the server to effectively place those clients in quarantine. When a client has a valid virus scan report indicating full time and/or real time virus protection, and/or virus eradication, then the client is permitted access to the server and the remaining network to the extent that the client has authorization. The virus monitor of the server can also quarantine clients that do not continuously enable virus protection. This latter feature is significant since when all clients maintain up-to-date virus protection, these clients will remain immune to viruses if a virus is somehow reintroduced into the system. Requiring full time virus protection of each client computer not only protects each client individually but also protects every other client in the system and the server. Accordingly, a method and system of network virus exclusion of the present invention minimizes initial virus infections of the system and dramatically reduces re-infection of viruses that were previously eradicated from the network.

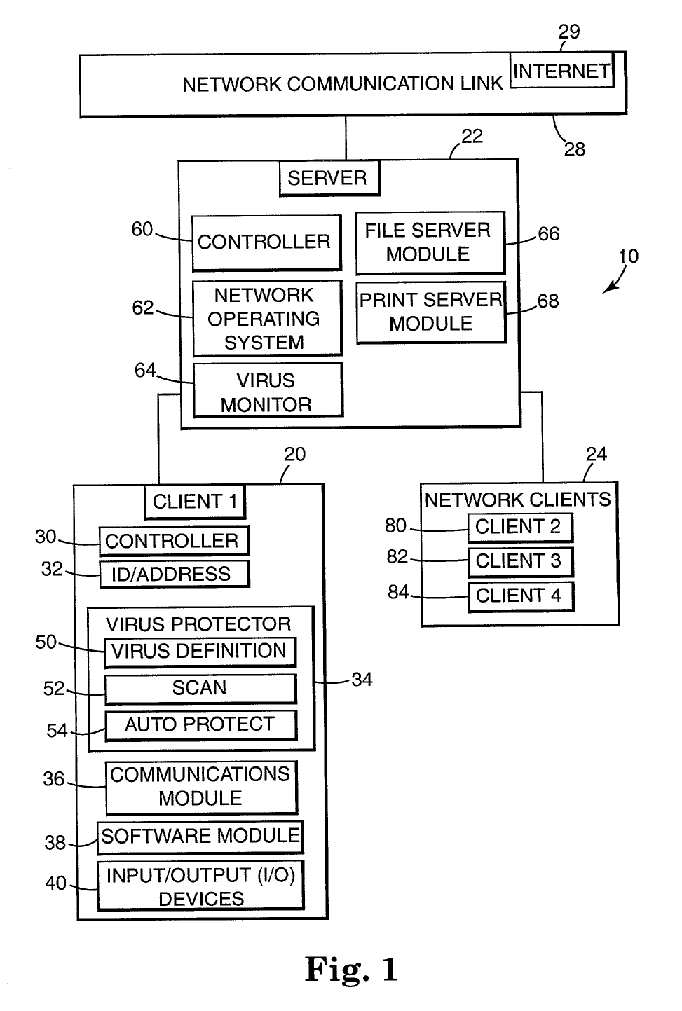

A method and system for virus exclusion of the present invention is illustrated generally at 10 in FIG. 1. System 10 includes first client 20, server 22, and network clients 24, as well as network communication link 28. First client 20 further includes controller 30, ID/address 32, virus protector 34, communications module 36, software module 38, and input/output devices 40. Server 22 further includes controller 60, network operating system 62,virus monitor 64, file server module 66, and print server module 68. Network clients 24 include second client 80, third client 82, and fourth client 84.

First client 20, server 22, and network clients 24 together comprise a client-server network. First client 20 comprises a single client computer such as a desktop computer or workstation, or portable computer. First client 20 operates substantially the same as network clients 24 and is highlighted for illustrative purposes to more fully describe the interaction between each first client 20 and server 22 in the system and method of network virus exclusion, according to the present invention. Accordingly, network clients 24, including second client 80, third client 82 and fourth client 84 all have substantially the same attributes and features as first client 20.

ID/address 32 of first client 20 uniquely identifies first client 20 among network clients 24 and other computing devices that communicate with server 22. Virus protector 34 of first client 20 comprises a software module for detecting and eradicating viruses from first client 20. Commonly known virus protectors are available from Symantec Corporation or McAfee Corporation. Virus definition function 50 includes virus definition files while scan function 52 uses those virus definition files for detecting viruses. Autoprotect function 54 allows a user of first client 20 to enable itself with fulltime virus protection for detecting and eradicating viruses.

Communications module 36 of first client 20 comprises any method through which first client 20 communicates with network clients 24 in network system 10, or beyond network system 10 through server 22. For example, communications module 36 includes capabilities for electronic mail, file transfer, internet browsing, etc. Software module 38 of first client 20 comprises any software application(s) operating on first client 20 such as its operating system, word processor, office program, etc., each of which are capable of acting as a platform for virus replication. Finally, input/output devices 40 comprise all devices that are part of first client 20, or connected to first client 20 and that are capable of importing data and executable programs into first client 20 and capable of exporting data and executable programs from first client 20. For example, input/output devices 40 include CD-drives, floppy disk drives, ZIP disk drives, tape drives, scanners, digital senders, etc. Input/output devices 40 also are devices and media through which a virus may spring and replicate.

Server 22 operates with first client 20 and network clients 24 in a client-server relationship. Controller 60 of server 22 and controller 30 of first client 20 includes hardware, software, firmware or combination of these. In one preferred embodiment, controller 30,60 includes a microprocessor based system capable of performing a sequence and logic operations. Server 22 further includes file server module 66 and print server module 68 for acting as a file server and/or printer server in network system 10.

Network operating system 62 of server 22 comprises a well known software system for operating a client-server network such as Novell Netware or Microsoft Windows NT. Network operating system 62 is capable of permitting access to server 22 and communications through and with server 22 at different levels of security. Authorized access and communications for first client 20 include filing sharing, client-to-client communications, and internet access and communications. Limited or conditional access and communications permit first client 20 only to identify itself to server 22 for conducting virus scans and for obtaining authorization for further access.

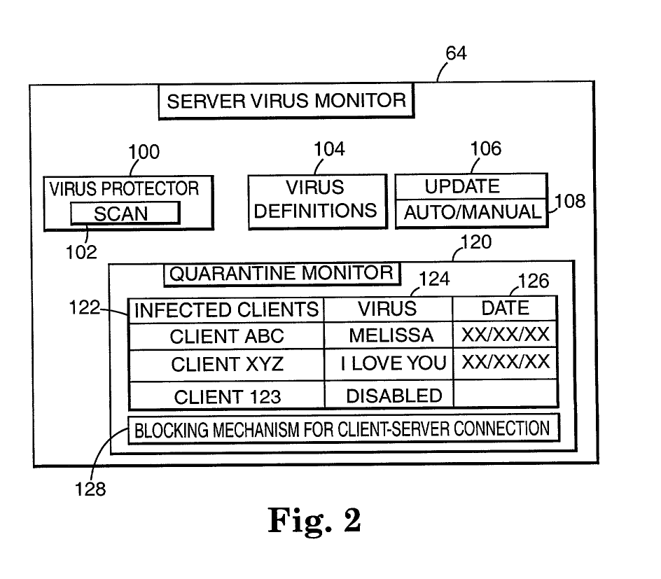

Virus monitor 64 of server 22 works with network operating system 62 and optionally is incorporated into network operating system 62 for preventing, detecting and eradicating a virus infection in network system 10. Foremost, in one aspect of a method and system of the present invention, virus monitor 64 of server 22 isolates virus-infected or virus-susceptible client computers such as a first client 20 from authorized communication with server 22 and network clients 24. Virus monitor 64 is more fully described later in association with FIG. 2.

Network communication link 28, as used herein, includes an internet communication link (e.g., the Internet), an intranet communication link, or similar high-speed communication link. In one preferred embodiment, network communication link 28 includes an Internet communication link 29. Network communication link 28 facilitates communication between clients 20,24 via server 22, and any internet entity such as web sites and network-provided software applications such as application service providers.

As shown in FIG. 2, virus monitor 64 of server 22 includes virus protector 100 with scan function 102, virus definitions 104 with update function 106 and auto/manual switch 108,and quarantine monitor 120 with infected clients listing 122, virus type listing 124, and date listing 126.

Virus protector 100 with scan function 102 uses virus definitions 104 to detect viruses at all levels of server communication with first client 20 and/or other devices, as well as network clients 24. Quarantine monitor 120 comprises a registry for tracking virus-infected client computers and which virus they each were infected with, and when the infection occurred. Quarantine monitor 120 also tracks virus-susceptible client computers, such as those without an up-to-date virus scan and/or those with disabled virus protection such as disabled virus protector 34. This information may be tracked cumulatively and used for detecting patterns in virus infection, detection and eradication. In combination with network operating system 62, quarantine monitor 120 identifies virus-susceptible client computers and virus-infected client computers for preventing their communication with server 22 and network clients 24, including which clients tend to infect the network system and/or fail to maintain virus protection. Finally, server virus monitor 64 includes blocking mechanism 128, which acts in cooperation with network operating system 62 for preventing or terminating a client-server connection for a specified client computer that is virus-susceptible or virus-infected. Operation of blocking mechanism 128 is reflected in and managed by quarantine monitor 120.

Network virus exclusion system 10 of the present invention can employ several different methods for excluding viruses from network system 10. In one aspect, the method of the present invention focuses on preventing authorized access to server 22 until a valid virus scan report, or report of enabled virus protection, is presented by first client 20 to server 22. In another aspect of the present invention, the methods focus on ways in which a client, that already has authorized access to server 22, is terminated from its client-server connection when a virus is detected on the client or if virus protection is disabled. In each case, first client 20 (or more network clients 24 that are similarly situated) is isolated from server 22 and from other network clients 24 by terminating a client-server connection to effectively place virus-susceptible client computers and/or virus-infected clients in quarantine.

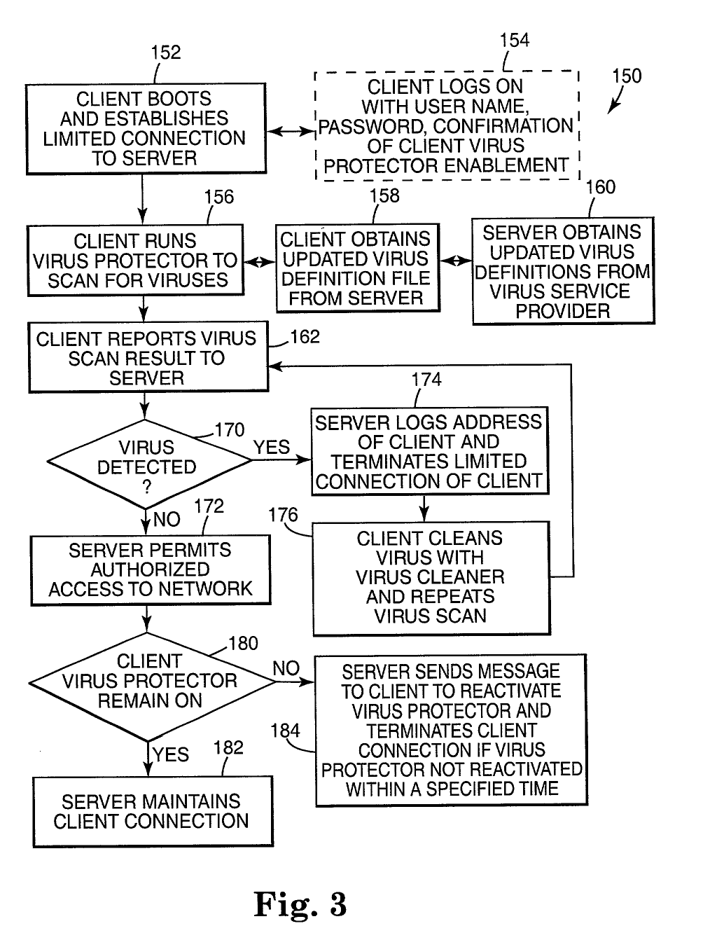

In one exemplary embodiment of the present invention, method 150 of network virus exclusion of the present invention is shown in FIG. 3. Method 150 includes a first step 152 in which first client 20 boots up and establishes a limited connection to server 22. First step 152 includes a further optional step 154 in which first client 20 logs onto server 22 with a user name, password and/or confirmation that client virus protector 34 is enabled. Whether or not optional step 154 is implemented, server 22 identifies first client 20 with ID/address 32.

Next, first client 20 runs client virus protector 34 to scan first client 20 for viruses (step 156). Step 156 optionally further includes step 158 in which first client 20, through its limited connection to server 22, obtains updated virus definitions from server 22 prior to performing the virus scan. In addition, step 158 optionally further includes server 22 obtaining an updated virus definition file from a virus protection service provider 160.

In step 156, first client 20 optionally uses a virus checker supplied by server 22 to scan for viruses on first client 20 (e.g., see virus protector 100 in FIG. 2). Server-based virus protector 100 is available to first client 20 through its limited connection with server 22.

First client 20 reports the results of its virus scan to server 22 (step 162). Server 22 determines whether a virus was detected (step 170). If no virus was detected, then server 22 permits authorized access for first client 20 to server 22 and the network (step 172). However, if a virus was detected in step 170, then server 22 logs client address 32 for identification of first client 20 and terminates the limited connection of first client 20 to server 22 (step 174). Following step 174, first client 20 cleans and removes the virus with a virus cleaner and repeats the virus scan (step 176). After virus disinfection step 176, step 162 is repeated in which first client 20 reports the results of its virus scan to server 20. When a successful virus scan report is sent to server 20 (i.e., no virus detected, as in step 170), then server 22 permits authorized access to network for first client 20 (172).

Once first client 20 has authorized access to server 22 (e.g., step 172) and the remaining network, first client 20 computes in a normal manner. During the ongoing computing session, virus monitor 64 of server 22 queries first client 20 to determine if client virus protector 34 remains enabled (step 180). If virus monitor 64 of server 22 determines that the client virus protector 34 has been disabled, then server 22 sends a message to first client 20 to reactivate virus protector 34 and terminates the client-server connection to server 22 if virus protector 34 has not been reactivated within a specified period of time (step 184). If the server 22 determines that client virus protector 34 remains in an enabled mode, then server 22 maintains the client-server connection with first client 20 (step 182).

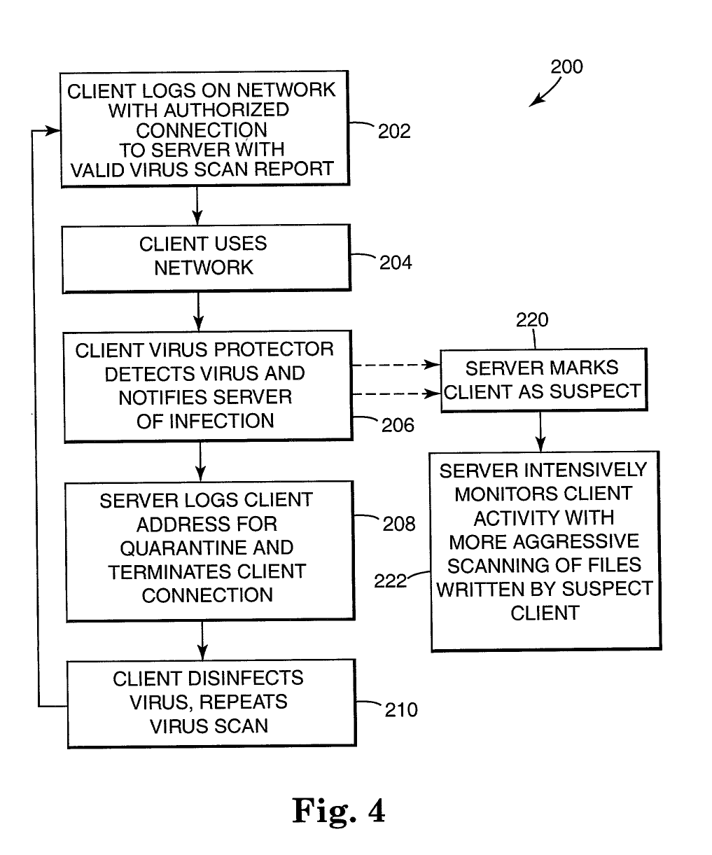

Another exemplary embodiment of a method 200 of network virus exclusion of the present invention is shown in FIG. 4. Method 200 includes a first step 202 in which first client 20 logs onto server 22 with authorized access to server 22 by providing a valid virus scan report to server 22. The valid virus scan report identifies that first client 20 has successfully scanned itself for viruses with an up-to-date virus definition file, and certifies that first client 20 has enabled full time virus protection. Next, first client 20 uses the network in a computing session with authorized computing privileges (step 204). In step 206, during the computing session, first client 20 detects a virus with client virus protector 34 and notifies server 22 of the action. The source of the virus may be from an e-mail, an e-mail attachment, or a file accessed on a storage media such as a diskette or CD drive. In a first primary response pathway, server 22 logs client address 32 for placing first client 20 in quarantine from server 22 and the remaining network, and then terminates the client-server connection (step 208). In response, first client 20 uses client virus protector 34 (with an updated virus definition file) to eradicate the virus and then repeats the virus scan (step 210). A successful virus scan results in a valid virus scan report. Accordingly, first client 20 can then again log on to the network by repeating step 202.

After first client 20 notifies server 22 of a virus infection in step 206, server 22 may take an optional secondary pathway. In the secondary pathway, server 22 marks first client 20 as suspect (step 220), and then intensively monitors activity of first client 20 by more aggressively scanning files written by suspect first client 20 (step 222).

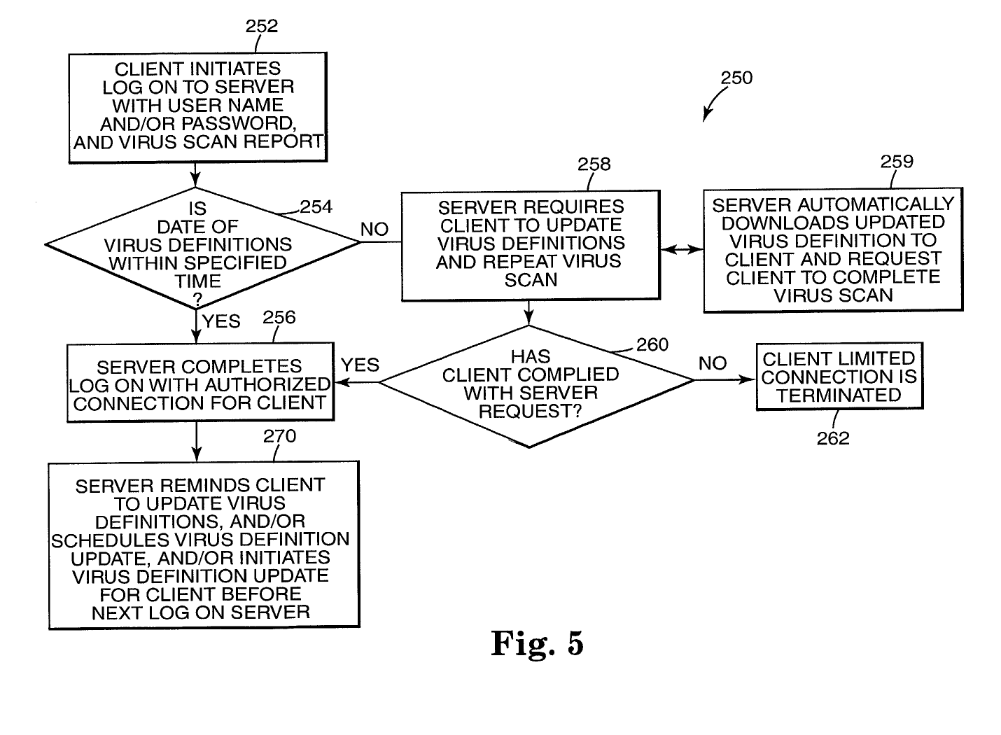

Finally, another exemplary embodiment of a method 250 of network virus exclusion of the present invention is shown in FIG. 5. Method 250 includes a first step 252 in which first client 20 initiates its log onto server 22 with a user name and/or password, and a valid virus scan report. If first client 20 is an authorized user and certifies a valid virus scan to server 22, then server 22 grants first client 20 a limited connection to server 22. However, before releasing first client 20 to authorized access to the network, server 22 determines if the date of virus definitions in the virus scan report were updated as of a specified date (step 254). In step 256, if the date of the virus definitions in the virus scan report meets the date criteria set by server 22, then server 22 establishes an authorized client—server connection with first client 20.

If the date of the virus definitions in the virus scan report from first client 20 fails to meet the date criteria set by server 22, then in step 258 server 22 requires first client 20 to update its virus definitions and repeat the virus scan. Step 258 optionally includes step 259 in which server 22 automatically downloads the updated virus definition file to first client 20 and requests first client 20 to complete an additional virus scan. Following the updating step 258, server 22 queries whether first client 20 has complied with the virus update request (step 260). If the client has not complied with the server update request, then in step 262 the limited connection between the server 22 and first client 20 is terminated. On the other hand, if first client 20 complied with the server request to update the virus definitions and successfully repeated the virus scan, then first client 20 participates in step 256 in which server 22 completes the connection between first client 20 and server 22 for authorized access to the network. Finally, in step 270, before the next log on to server 22 by first client 20, server 22 reminds first client 20 to update its virus definitions, schedules a virus definition update, and/or initiates a virus definition update for first client 20

A system and method for network virus exclusion of the present invention isolates virus-susceptible clients and infected clients from a server of a network and from other network clients to prevent virus transmission throughout the network. Placing those clients in quarantine prevents virus transmission from those quarantined client computers. Moreover, requiring all other client computers to maintain full time virus protection prevents rampant virus transmission from an infected client computer. Finally, by tracking the addresses of client computers that fail to maintain virus protection and/or which regularly incur virus infections, a network administrator can take further measures against the perpetrators, such as closely scrutinizing activities of those client computers as well as denying the client computer's network computing privileges for a period of time.

While specific embodiments have been illustrated and described, herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of network computing:
using a server with a virus monitor to identify a client computer that is infected with a virus or susceptible to a virus; and
isolating the virus-infected client computers and virus-susceptible client computers from the server and from a computing network connected to the server.

2. The method of claim 1 wherein the using step further comprises:
scanning the client computer with a virus monitor of at least one of the server and the client computer.

3. The method of claim 1 wherein the isolating step further comprises:
tracking a client identifier of the virus-infected and virus-susceptible client computers; and
preventing a client-server connection and network communications between the virus-infected client computers and virus-susceptible client computer and the computing network.

4. The method of claim 1 wherein the using and isolating steps further comprise:
detecting client computers that do not maintain an enabled virus protector; and
terminating a client-server connection for client computers that have a disabled virus protector.

5. The method of claim 1 wherein the using and isolating steps further comprise:
detecting client computers that are not enabled for virus protection during an attempted client server connection; and
preventing a client-server connection for those non-enabled client computers.

6. A method of virus-controlled network access comprising:
using a server of a network with a virus monitor to identify client computers that fail to produce an approved virus scan report; and
isolating client computers without an approved virus scan report from authorized communication with the server.

7. A method of maintaining a virus-controlled network computing system comprising:
booting a client computer to establish a client-server connection with a server and to scan the client computer for a virus;
reporting the results of the virus scan from the client computer to the server;
selectively permitting the client computer authorized access to the server through the client-server connection when the virus scan report detects no viruses and denying the client computer access to the server when a virus is detected or no valid virus report is provided by the client computer.

8. The method of claim 7 and further comprising:
establishing the client-server connection based on the client computer maintaining a virus protector of the client computer in an enabled mode.

9. The method of claim 7 wherein the terminating step further comprises:
querying the client periodically to determine if the virus protector of the client computer remains enabled.

10. The method of claim 7 and further comprising:
terminating the client-server connection if the virus definitions of the virus protector of the client computer have not been updated within a specified date criteria of the server.

11. A method of preventing network virus migration within a network comprising:
monitoring a virus susceptibility of each client computer of the network; and
tracking virus susceptible client computers and preventing a client-server connection between each virus-susceptible client computer and the server.

12. The method of claim 11 wherein the monitoring step further comprises:
determining virus susceptibility based on whether a virus protector of the client computer is enabled.

13. The method of claim 11 wherein the monitoring step further comprises:
determining virus susceptibility based on whether the client computer presented the server with a valid virus scan report.

14. The method of claim 11 wherein the tracking and preventing step further comprise:
terminating the client-server connection for at least one of a virus susceptible client computer and a virus-infected client computer.

15. The method of claim 14 wherein the tracking and preventing step further comprise:
identifying an address of each virus-susceptible and virus-infected client computer to selectively prevent further client-server connections with those client computers by establishing a quarantine of the identified client computers.

16. A virus exclusion network system comprising:
a client computer including a virus protector;
a network server including a virus monitor configured for preventing an authorized network connection between the client computer and the server when the client computer fails to produce at least one of a report of an up-to-date virus scan of the client computer and a confirmation of enablement of the virus protector of the client computer.

17. The system of claim 16 wherein the client computer further comprises:
a virus protector for scanning the client computer for viruses.

18. The system of claim 16 wherein the virus monitor of the server further comprises:
a virus protector for scanning the client computer and files written by the client computer.

19. A server comprising:
a controller;
a virus monitor including:
a virus protector with a scanning function;
a virus definition source; and
a quarantine monitor configured for preventing a client-server connection for client computers that are virus-infected or virus-susceptible and configured for tracking an identity of those client computers.

20. A client computer comprising:
a controller;
a virus protector configured for detecting and eradicating viruses on the client computer, for maintaining real-time virus protection, and for producing a report to a server to confirm that the client computer is virus-free and thereby eligible to connect to the server with authorized access privileges.

21. A computing network virus monitor comprising:
a virus protector;
a quarantine monitor configured for preventing network communications originating from a client computer that is virus-infected or virus-susceptible and configured for tracking an identity of those client computers.

22. A virus quarantine monitor of a server comprising:
a client computer identifier;
a virus identifier; and
a blocking mechanism configured for signaling the server to prevent client-server connections with client computers identified as being virus susceptible or virus-infected.

23. A computer-readable medium having computer-executable instructions for performing a method of network virus exclusion, the method comprising:
identifying client computers that are at least one of virus-susceptible and virus-infected; and
isolating virus-susceptible client computers and virus-infected client computers from authorized communication with a server of the network.

24. A computer-readable medium having computer-executable instructions for performing a method of preventing network virus migration within a network, the method comprising:
monitoring a virus susceptibility of each client computer of the network; and
tracking virus susceptible client computers and preventing a client-server connection between each virus-susceptible client computer and the server.

25. A computer-readable medium having computer-executable instructions for performing a method of network computing, the method comprising:
using a server with a virus monitor to identify a client computer that is infected with a virus or susceptible to a virus; and
isolating the virus-infected client computers and virus-susceptible client computers from the server and from a computing network connected to the server.

26. A computer-readable medium having computer-executable instructions for performing a method of monitoring network connections, the method comprising:
preventing an authorized network connection between a client computer and a server when the client computer fails to produce at least one of a report of an up-to-date virus scan of the client computer and a confirmation of enablement of the virus protector of the client computer.

27. A computer-readable medium having computer-executable instructions for performing a method of quarantining client computers, the method comprising:
preventing a client-server connection for client computers that are virus-infected or virus-susceptible; and
tracking an identity of the virus-infected and virus-susceptible client computers.
